(19) United States
(12) Patent Application Publication
(10) Pub. No.: US 2015/0081379 A1
(43) Pub. Date: Mar. 19, 2015

(54) SYSTEM FOR MONITORING SAFETY PROTOCOLS

(71) Applicant: ACM AUTOMATION INC., Calgary (CA)

(72) Inventors: Patrick FISHER, Calgary (CA); Ken BINGHAM, Calgary (CA)

(21) Appl. No.: 14/561,526

(22) Filed: Dec. 5, 2014

Related U.S. Application Data
(63) Continuation-in-part of application No. 13/271,711, filed on Oct. 12, 2011.

(51) Int. Cl. G06Q 10/06; G06Q 50/26

(52) U.S. Cl. CPC G06Q 10/0635; G06Q 50/265
USPC 705/7.28

(57) ABSTRACT

A system for monitoring the impact of lack of safeguards and procedures and for converting that into a metric of risk for any industrial facility or transportation of the same substances or products. A user interface allows access to a database containing safety documents for all safeguard's and procedures. The user interface also interfaces with a safety calculation module that calculates the risk level for specific potential consequences if specific safety procedures are not implemented and if specific safeguards become unavailable in any way. The calculation module calculates risk on a per scenario basis using a risk performance indicator, (RPI), metric. This metric is calculated as the difference between projected risk and tolerable risk. A total risk for an area of a facility can be calculated by summing all risk performance indicator metrics for all scenarios in that area.

### TECHNICAL FIELD

The present invention relates to process Risk management. More specifically, the present invention relates to systems and methods for determining the risk impact on loss of safety procedures and safeguards for industrial facilities and transportation systems such as railroads, pipelines, trucks, and ships.

### BACKGROUND OF THE INVENTION

Large-scale industrial accidents due to the failure of safeguards and procedures should be a thing of the past. Industrial facilities and transportation systems handling the same hazardous substances and products, especially those relating to chemical processes, can now be designed with safety procedures and safeguards for life of asset. These safety procedures and safeguards include periodic scheduled safety checks on the various components of such a facility. Safeguard's which may fail, become removed, are not performed, become bypassed or simply lose integrity without regular inspection and testing programs involve operating inspections, alarm response procedures, operator observations, trip systems, valves, pipes, seals, instruments, and safety workers checks. All these are monitored. The combination of monitoring these safeguards and relating to the risk under Process Risk Management determine the overall risk of a facility to people, assets, reputation and the environment. As these events occur, they are reported and the resulting risk is calculated and display on the invention. Contingencies and procedures to compensate for loss of safeguards are made available on the invention.

Unfortunately, the understanding of what the risk impacts are due to missed scheduled maintenance checks are not always the easiest to keep track of and, invariably, this understanding can be missed. This is especially true for facilities with hundreds if not thousands of components that need checking.

Another issue and more importantly as new operating personnel are on-board and more experienced operating personnel retire the understanding of the risk impact of lack of maintenance and checking of components is missed. It's only clearly understood at the design stage when all the disciplines including process designers, operations, maintenance experts, and management develop a statement of requirements and assumptions stating that all maintenance, training, operators knowledge are firmly in place at all times. This assumption is never true in an operating environment as these environments are exposed to changes in process, equipment, and people. These all impact the integrity of the safeguards. This is something that safety workers are not usually cognizant of the consequences of equipment failure or of the risks being exposed due to unavailable safeguards. These potential risks are usually known at the time the facility is designed and at the time the components are provisioned. However, as with the scheduled safety maintenance checks these potential risks may easily get lost as the facility and its equipment ages.

If the safeguard's and procedures fail, and there is a process demand then there is no reason why a significant consequence will not happened. These demands can involve process demands like overfill, over pressure, over temperature, low temperature, vacuum, loss of control. These demands can also be external like wind, rain, fire, earthquakes, flooding, and sabotage. When demands occur and safeguards and procedures fail the consequences may be dire for the facility, the people, the corporation, the environment, and the reputation. There is significant data and history of events where all these consequences continue to happen somewhere in the world every week. The human aspect and thinking “it will not happen here” remains prevalent.

There is therefore a need for systems or methods that can be used to monitor Process Safety Risk and not only the scheduled maintenance, safety check schedules, alarms, and trips, but also the understanding of what a measure of risk accumulation is on loss of safeguards and procedures. Consequences can become significant quickly. Hidden failures of safeguards is a common threat but even more common is the lack of understanding of what it means when safeguards are not available should a process demand occur during that time.

### SUMMARY OF INVENTION

The present invention relates to a system to monitor the impact of lack of safeguards and procedures and convert that into a metric of risk for any industrial facility or transportation of the same substances or products. A user interface allows access to a database containing safety documents for all safeguard's and procedures. The user interface also interfaces with a safety calculation module that calculates the risk level for specific potential consequences if specific safety procedures are not implemented and if specific safeguards become unavailable in any way. The calculation module calculates risk on a per scenario basis using a risk performance indicator, (RPI), metric. This metric is calculated as the difference between projected risk and tolerable risk. A total risk for an area of a facility can be calculated by summing all risk performance indicator metrics for all scenarios in that area.

In a first aspect, the present invention provides a system for monitoring safety related procedures relating to safeguards and procedures in a facility, the system comprising:
A safety operator user interface for providing a safety operator with alarms and information relating to a plurality of failed and unavailable components and procedures in said facility;
A database of safety related documents, said documents being accessed by said user interface to determine if safety procedures for said plurality of components are being implemented;
a safety calculation module for calculating risk levels if said safety procedures for said plurality of components are not implemented, said risk levels being presented to said safety operator through said user interface, said risk levels being related to at least one consequence if said safety procedures are not implemented;

Wherein said safety calculation module calculates at least one risk level for at least one scenario using a risk performance indicator metric, said risk performance indicator metric being calculated as tolerable risk subtracted from projected risk.

In a second aspect, the present invention provides a system for monitoring safety related procedures relating to specific components in a facility, the system comprising:
A user interface for providing alarms and risk information relating to said Safeguards and procedures;
A database of safety related documents, said documents being accessed by said user interface to determine if safety procedures for said specific components are being implemented;

The related documents referred to include Risk Assessment files such as, but not limited to, Process Hazards Analysis, HAZOP's. LOPA's, SRS's, and other related files. Most of these would have been created during the design of facilities by the design and operating companies.
a safety calculation module for calculating risk levels relating to potential consequences if said safety procedures for said specific components are not implemented, said risk levels being presented to said safety operator through said user interface, said safety calculation module calculating said risk levels on a per scenario basis using a severity of consequence multiplied by a difference between projected risk and tolerable risk.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a screen shot of a dashboard screen of a user interface according to one aspect of the invention;

FIG. 3 is a screen shot of a situational analysis screen of the user interface;

FIG. 4 is a screen shot of an alarm notes view of the situational analysis screen;

FIG. 5 is a screen shot of a contingencies view of the situational analysis screen;

FIG. 6 is a screen shot of an observation view of the situational analysis screen;

FIG. 7 is a screen shot of a history view of the situational analysis screen;

FIG. 8 is a screen shot of another contingencies view of the situational analysis screen;

FIG. 9 is a screen shot showing a popup window that occurs when a component fails;

FIG. 10 illustrates a bowtie configuration used as a visualization of a hazardous event with multiple potential causes and multiple potential consequences;

FIG. 11 illustrates a simple scenario with one cause leading to one consequence;

FIG. 12 illustrates the bowtie configuration of FIG. 10 after one layer of protection has failed;

FIG. 13 illustrates the bowtie configuration of FIG. 10 after two layers of protection have failed;

FIG. 14 is a screenshot of a user interface screen illustrating a bowtie configuration for a specific event as presented to a user.

### DETAILED DESCRIPTION OF THE INVENTION

The present invention relates to process risk management. And, in one aspect, the present invention determines the risk impact on loss of safety procedures and safeguards for industrial facilities and transportation systems. These facilities are inherently hazardous as they typically handle hazardous substances and are being operated at high temperatures and pressures. The safeguards and procedures rely on people to test and maintain the engineered design and Risk Assessment study(s). If these safeguards and procedures are not implemented or followed, this invention determines the resulting risk impact to operations. The invention deals with magnitudes of likelihood of an unwanted consequence relating to people, assets, environment and reputation. One basis of the invention is that if the design of a facility is based on a risk assessment, then the risk assessment data and interpretation of the risk should become part of operations to be as safe as the day the plant started up or the last change was implemented.

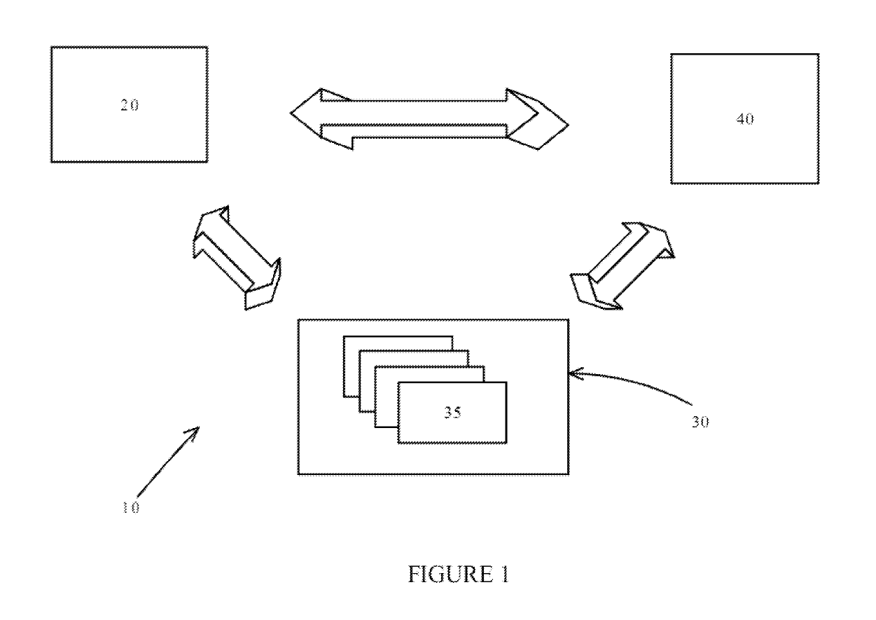

Referring to FIG. 1, a block diagram of a system according to one aspect of the invention is illustrated. The system 10 comprises a user interface 20, a database 30, and a calculation module 40.

The system illustrated and described below can be used to implement aspects of the international standard IEC 61511. IEC 61511 is important for Safety Instrument Systems, (SIS). These types of safeguards comprise only 5-10% of most safeguarding systems. However, the concept of Risk Reduction (RR) used by SIS applies to all safeguards. Where an SIS can reduce the likelihood of occurrence should a demand occur by a factor (e.g. by a factor of 100), so can a mechanical safeguard such as a Process Safety Valve (PSV) reduce the likelihood of occurrence should a demand occur by a factor of 100. The factor of 100 for the SIS system would be labelled a SIL 2. The factor of 100 for the PSV would be labelled with a risk reduction of 100.

The database 30 contains safety documents 35 for the components being used in safeguards and procedures. The safety documents are preferably documents prepared by design engineers while designing and constructing the facility or its related systems. Also preferably, each component and subcomponent of the facility is provided with a corresponding safety document that documents the projected life span of the component, a suitable maintenance schedule for the component, a suitable safety inspection schedule for the document, as well as other useful safety requirements specification (SRS) related data and metrics for the component or subcomponent. In one implementation, the safety documents 35 in the database 30 can be the Safety Requirement Specification (SRS) documents for each component in the facility. These SRS documents ideally detail potential consequences if a specific component fails or performs in a manner less than what is expected from the component. The SRS document may also contain rules and information relating to the calculation of risk levels for each of the potential consequences if the specific component fails.

The calculation module 40 calculates the various risk levels associated with each of the potential consequences if the specific component fails or functions in a less than expected manner. These risk levels are calculated using data derived from the safety documents in the database 30. These risk levels are accessible to the user interface 20. As will be seen below, risk levels can be presented to the safety operator using various user interfaces. One example of a calculation that the calculation module may make is the PFD_{avg} or the probability of failure on demand average for each component. The PFD_{avg} of a safety instrumented function (SIF) loop can be calculated using:

$$P F {D}_{IEC} = {λ}_{D} [ ( 1 - DC ) ( \frac{{T}_{1}}{2} + M T T R ) + ( DC \times M T T R ) ] \qquad ( 1 )$$

Where:
PFD_{IEC} is the probability of failure of demand average of the component as per IEC 61508
λ_{D} is the dangerous failure rate of the component
DC % is the diagnostic coverage applied to the component
Tᵢ is the proof test interval for the component
MTTR is the mean time to restore a component from failed to working state.

To avoid probabilities greater than 1, the equation below may be used by the calculation module 40:

PFD_{True}=1−e^{-PFD}^{_{IEC}} (2)

For independent components in MooN combinations (i.e. M out of N elements must work for the component to work), the equation below has been used for all combinations where M≦N:

$$P F {D}_{Total} = {\sum }_{i = N - M + 1}^{N} \frac{N !}{i ! ( N - l ) !} ( {( P F {S}_{True} )}^{N} {( 1 - P F {D}_{True} )}^{N - i} ) \qquad ( 3 )$$

For common cause failures in redundant combinations, the PFD_{avg} can be calculated using Equation (4):

$$P F {D}_{Total} = \{ {\sum }_{i = N - M + 1}^{N} \frac{N !}{i ! ( N - i ) !} ( {( P F {D}_{True} )}^{N} {( 1 - P F {D}_{True} )}^{N - i} ) \} + ( β \times P F {D}_{True} )$$

where β is the common cause factor between redundant elements. Other calculations performed by the calculation module may be found in IEC61508 standard (IEC being the International Electro technical Commission).

The user interface 20 presents data to a safety operator upon which the safety operator will base his or her decisions regarding the safety of the facility. The user interface 20 has a number of screens from which the safety operator can see various data relating to potentially unsafe situations as well as contingencies which may be implemented.

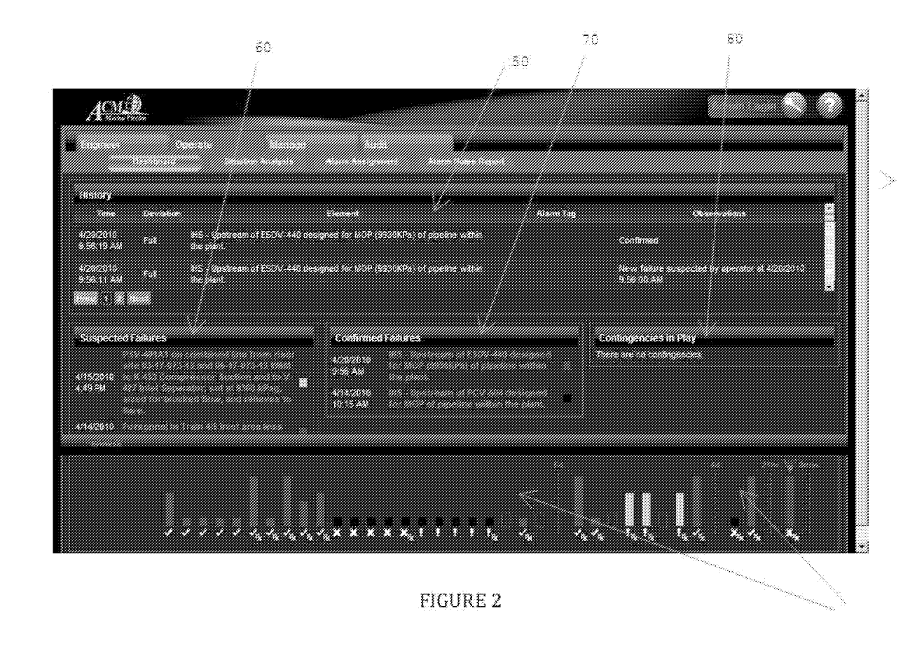

Referring to FIG. 2, a screen shot of one user interface screen according to one implementation is illustrated. FIG. 2 shows a dashboard screen of the user interface 20. As can be seen, a history section 50 details a history of previous alarms or potentially unsafe situations. The history section 50 details the element or component to which the alarm relates as well as the date and time of the alarm. Finally, the history section details observations made by the safety operator in regard to each of the alarms. This history section can be scrolled down to show more entries of previous alarms.

Also shown in FIG. 2 are suspected failures 60 as well as confirmed equipment or component failures 70. These sections identify the component, the date/time of the suspected or confirmed failure, and, using a color-coded system, the risk of consequences due to the component failures. Also present is a contingencies section 80. This section shows any contingencies that are currently implemented due to safety concerns. As can be seen, no contingencies are in effect.

FIG. 2 also shows a quick reference timeline 90 at the bottom of the user interface screen. The timeline shows the various alarms or unsafe situations that have occurred or could have occurred. Unsafe situations are identified as those with less risk reduction in place than intended. This increases the likelihood of an undesirable consequence should a process demand occur. New color-coded icons or bars representing unsafe situations enter from the right of the user interface along with a changing time bar detailing how much time has elapsed since the unsafe situation was detected. As can be seen from FIG. 2, the unsafe situation represented by the red bar occurred 3 minutes before and has not been addressed. The color coding used in this implementation uses a red color to detail a potentially serious situation with dire consequences while a yellow color details a less serious situation. From FIG. 2, it can be seen that, prior to the current unsafe situation (detailed by the red bar), the previous event was more than 21 hours ago.

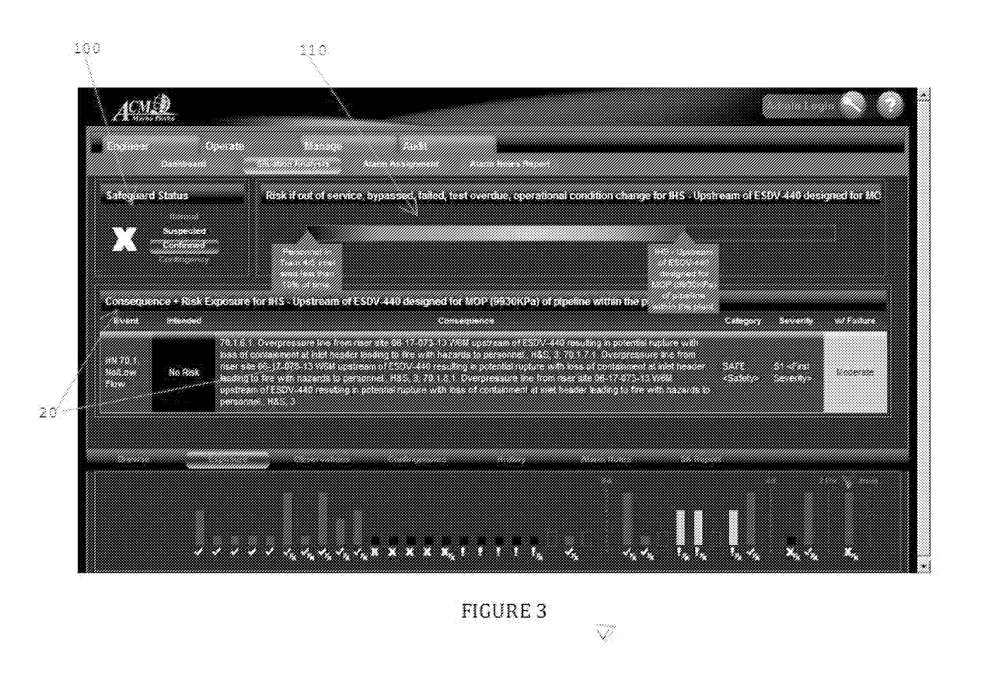

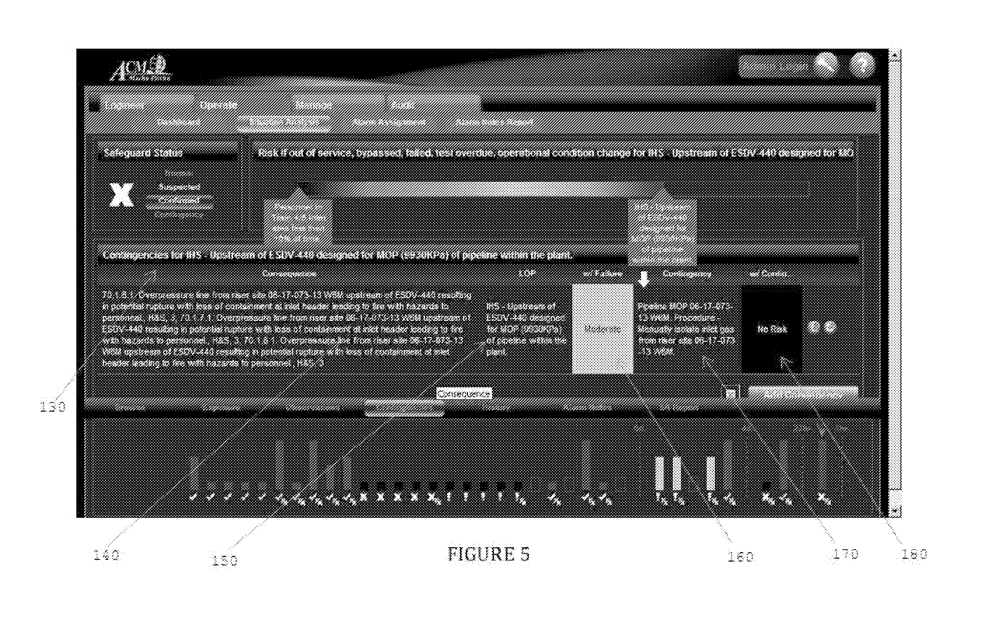

Referring to FIG. 3, a situational analysis screen of the user interface is illustrated. The situation analysis screen provides the safety operator with data relating to the potential consequences of an unsafe situation. A safeguard status section 100 shows the current status of an unsafe situation currently being viewed on the situation analysis screen. The safety operator can select NORMAL to change the status of the unsafe situation to normal, representing that the situation is no longer unsafe. Selecting the SUSPECTED category in the status section 100 will change the status of the unsafe situation to suspected, representing that the situation is potentially unsafe. Selecting the CONFIRMED category in the status section 100 will change the status of the unsafe situation to confirmed, representing that the situation is confirmed to be unsafe. Selecting the CONTINGENCY category in the status section 100 will prompt the safety operator to select an appropriate contingency (FIG. 5) to mitigate the unsafe situation.

A risk bar section 110 presents the risk level to a user (e.g. an operator, engineer, maintenance, manager, or safety expert) with a visual indication as to the risk being run if the potentially unsafe situation is allowed to continue. The color on the risk bar shows the current risk reduction and if the safeguard is normal (Grey) or out of normal (color). In this implementation green indicates minimal risk, yellow indicates more risk, and red indicates high risk. As can be seen in the risk bar section, multiple situations are represented on the risk bar. The situation indicated by the gray box to the left of the risk bar is one where the risk is normal or meets the intended design risk while the situation indicated by the gray box to the right of the risk bar indicates a situation where the risk exceeds the intended design risk.

A consequence section 120 details the consequences if the potentially unsafe situation is allowed to continue. As can be seen from FIG. 3, this section details not just the event, but also a detailed description of the consequence, the category of the consequence (i.e. what it affects), the severity of the consequence, and the risk as to whether the consequence will occur if the component fails. Finally, the consequence section also shows whether the design or use of the component was intended to engender any risks (i.e. are risks expected with this component).

It should be noted that the consequences are categorized into a number of categories. The categories normally include:

SAFETY—the consequence relates to the safety of the workers or of the facility

ENVIRONMENTAL—the consequence relates to an environmental impact

ECONOMIC—the consequence relates to a potential economic impact on the business

REPUTATION—the consequence relates to the reputation of the company and its ability to conduct business and continue to be trusted and respected.

It should further be noted that the risk levels shown in the consequences section may be categorized into multiple levels. In one implementation, the risk levels were categorized into ACCEPTABLE, MODERATE, or SERIOUS. These levels were, in this implementation, also color coded with ACCEPTABLE being shown by a green field, MODERATE being shown by a yellow field, and SERIOUS being denoted by a red field.

The situational analysis screen in FIG. 3 has multiple views. FIG. 3 shows the exposure view where the user can view the risk exposure for the various potentially unsafe situations

It should be noted that the component relating to each potentially unsafe situation is identified in each section in which the potentially unsafe situation is being examined. As can be seen, the component name is not limited to part numbers but can be quite descriptive. In both FIGS. 2 and 3 one element is named as “IHS—Upstream of ESDV-440 designed for MOP (9930 KPa) of pipeline within the plant” and, from FIG. 2, the failure of this component has been confirmed by the safety operator.

Also part of the situational analysis screen is a quick reference timeline 90 similar to the timeline found in FIG. 2.

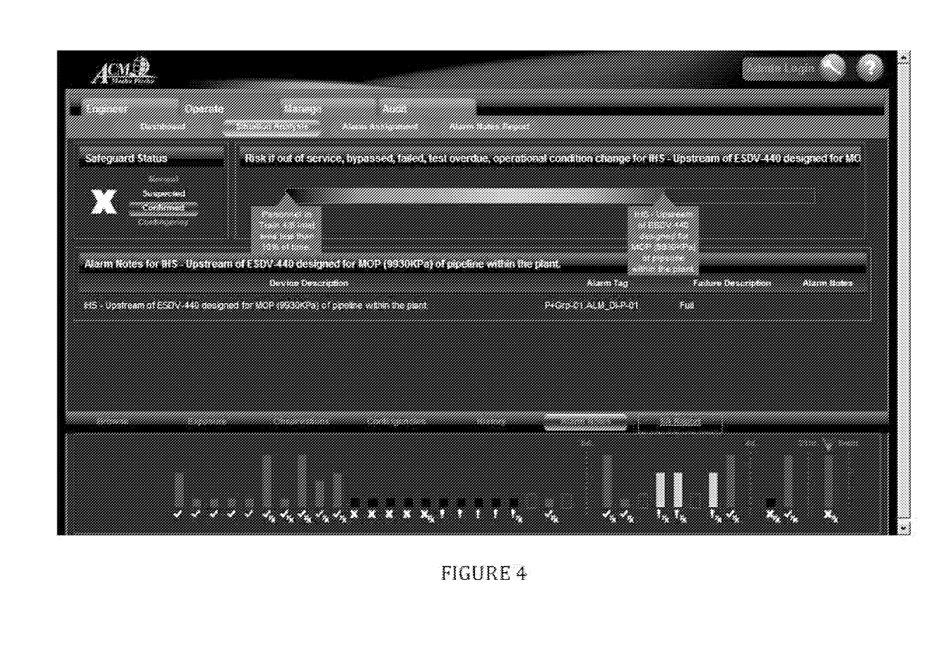

Referring to FIG. 4, another view of the situational analysis screen is illustrated. The view in FIG. 4 provides the safety operator with alarm notes regarding one of the unsafe situations. From FIG. 4, the notes relate to the alarm generated for the IHS component whose failure has been confirmed by the safety operator.

To compensate for the issues caused by an unsafe situation (perhaps caused by a failure of a component), contingencies for each unsafe situation are provided for in the situational analysis screen. Referring to FIG. 5, the contingencies view is shown. This view provides the safety operator with the contingency for each unsafe situation. A contingency section 130 displays not just the potential consequence (see consequence portion 140) but also identifies the component whose failure can cause the consequence (component portion 150), and the risk of the consequence occurring if the component fails (risk portion 160). The contingency section also identifies the contingency for a component failure (contingency portion 170) and the risk of the consequence if the contingency is implemented (modified risk portion 180). For this example, the consequences are quite dire as a fire is possible with its attendant dangers to personnel and the risk of the consequence occurring is moderate. With the contingency in place, the risk of the consequence has been eliminated.

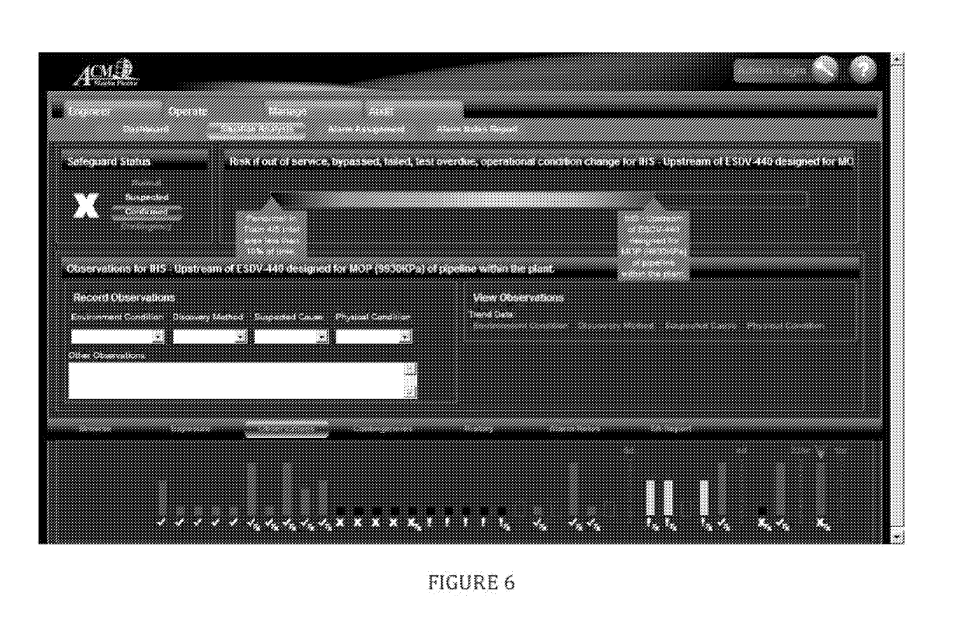

Referring to FIG. 6, shown is the observation view of the situational analysis screen. This view allows the user to add his or her observations regarding the potentially unsafe situation. User observations may include circumstances surrounding the unsafe situation such as a noisy valve, or leaking tank, or a strange smell. These observations then become part of the permanent record for that component. The observations can place a safeguard into suspect and highlight an unsafe situation with multiple scenarios requiring multiple contingencies. The observations are added to the safety document for the particular component, with the safety document being uploaded to the database. Any future access to the safety record for that component will then be able to retrieve the observations for this unsafe situation.

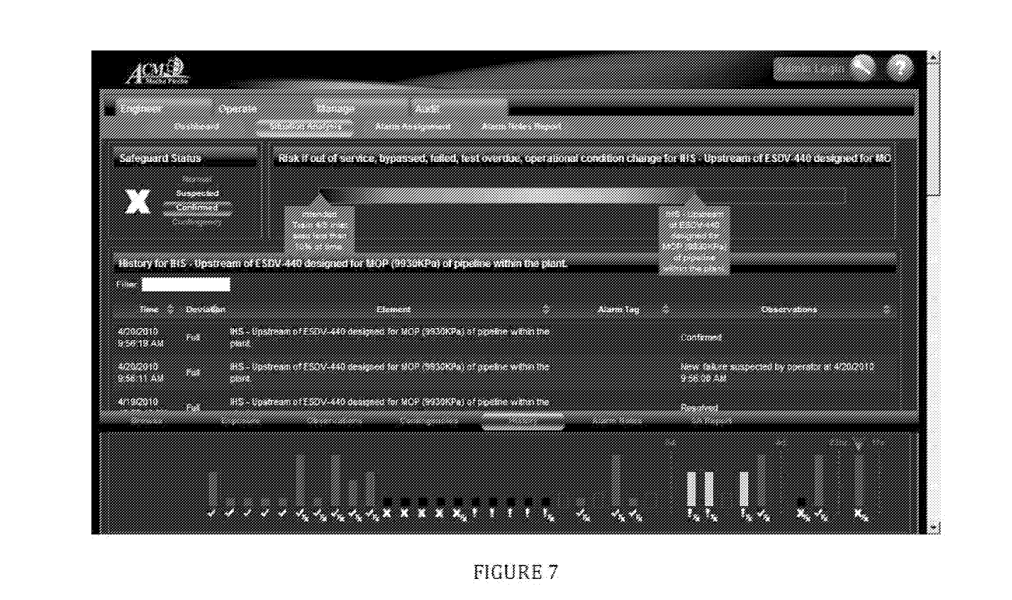

Referring to FIG. 7, the user can review the history of the safeguard through the situational analysis screen. This history may include the history of the safeguard or of a sub-component of the safeguard. As an example, the sub-component might include a solenoid valve which is only one component of a safeguard function. Other sub-components have to also work for this safety function to work, e.g. on high level a high level transmitter transmits a signal to a PLC which computes if action is required and sends a signal to a solenoid which controls a valve which, in turn might shut off the flow to a vessel. This historical view available through the situational analysis screen provides the safety operator with a complete history of any anomalies, problems, alarms, and potential issues with the particular component. The alarm view also provides any alarm tags associated with each event concerning the particular component, the date and time of each event, as well as any observations made regarding the event by the safety operator at the time. As can be seen from FIG. 7, a previous issue with the particular component was resolved while the current issue was first suspected and then confirmed by the safety operator.

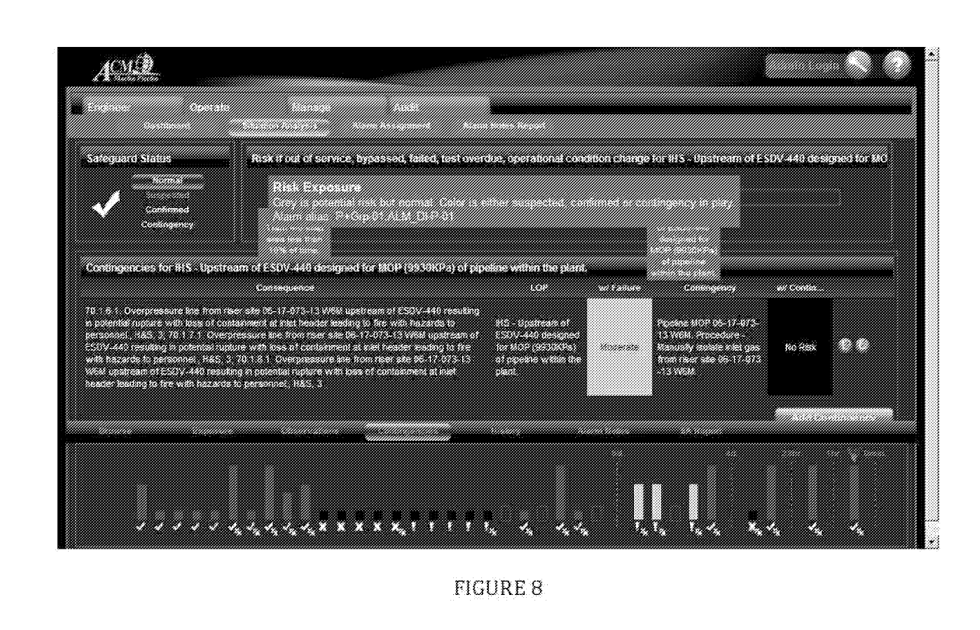

FIG. 8 is a screen shot of the situational screen using the contingency view detailing normal safeguard status. As explained in the mouse over (hovering a pointer over a specific section gives a popup explanation of that section) illustrated in FIG. 8, the safeguard status section is color coded. If there are suspected alarms, confirmed failures, or contingencies in effect, these will be indicated by a non-grey color. This use of a non-grey color to indicate suspected alerts, failures, etc. can be seen in the safeguard status in FIGS. 3, 5, and 6 as well.

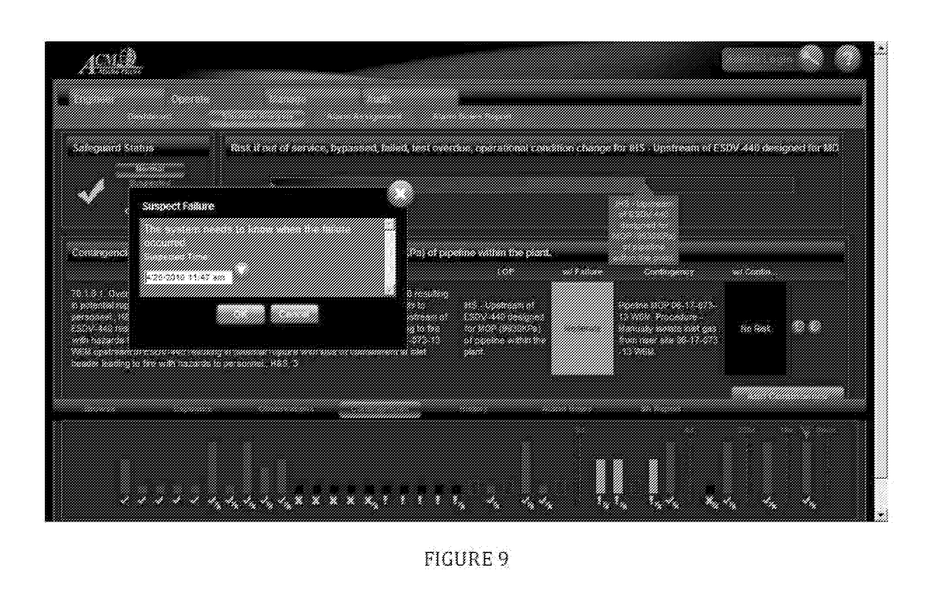

FIG. 9 details a popup window when a failure of a component is suspected. As can be seen, the safety operator is prompted for details, such as date and time, regarding the suspected component failure.

The system 10 operates with the user interface retrieving relevant safety documents from the database. As noted above, each component in the facility has at least one safety document in the database. Each component's safety data, including contingencies, schedules, safety history, and notes and observations on relevant safety alarms concerning the component, are detailed in the safety documents. When a user accesses data regarding a component, this causes the safety documents relating to that component to be retrieved from the database. The relevant data in the safeguards and procedures are then presented to the safety operator. This relevant data may, depending on the screen on the user interface, include the contingencies for component failure, the component's history (including false alarms, suspected failures, confirmed failures, etc.), maintenance schedules, safety operator notes and observations, as well as other safety related data.

The safety document(s) for each component may be added to by the user at any time. Documentation may be added after unsafe situations, or when failures have occurred and more information is required for a better understanding of the situation or failure. The data regarding such events are then entered into the relevant safety documents for the affected/relevant components. The amended safety documents are then uploaded to the database.

The risk data (i.e. the data relating to the risk of the consequences occurring) are retrieved by the user interface from the calculation module. The risk data may include all HAZOP, LOPA, Contingency plans, Safeguard information, SRS specifications, and consequence descriptions. The calculation module calculates this risk data based on safety data retrieved from the relevant safety documents from the database.

It should be noted that the safety documents or the information contained in these documents may be pre-retrieved by the user interface or by the calculation module prior to being needed by either of these. As an example, the user interface may retrieve all the safety documents from the database for all the components when the user interface is initialized. These safety documents can then be cached until needed by the user interface. Similarly, the risk data for various contingencies and components may be pre-calculated by the calculation module and cached by the user interface until needed or the risk data may be saved in the relevant safety documents for use by the user interface when needed.

In one embodiment, the present invention is implemented as a software system having multiple modules. The user interface module, the database, and the calculation module may be implemented on a single computer. Alternatively, each module may be resident on a separate server with each server being in networked communication with every other server. Similarly, some of the modules may be resident on the same server while others may be on another server.

In one implementation, the calculation module may be the SafeGuard Profiler tool marketed by ACM Automation Inc. of Calgary, Alberta, Canada.

It should be noted that differing methods of measuring risk may also be used with the invention. As an example, a Layer of Protection Analysis (LOPA) may be used to calculate the risks involved in a system or a process.

To assist the reader in understanding the following explanation, a glossary is provided below:
LOPA: Acronym for Layer of Protection Analysis. This is a well established process for analyzing process risk and assigning quantitative values to the consequence and likelihood of a hazardous event occurring. Data created in the LOPA process is the key data used to calculate RPIs (Risk Performance Indicator explained below).
Risk: Risk in the context of this invention is Process Risk and is defined as the risk arising from the process conditions caused by abnormal events including failure of a basic process control system. Risk is a combination of frequency of occurrence of harm and the severity of that harm.
Tolerable Frequency (TF): This is the maximum acceptable likelihood of an unwanted consequence occurring as a result of a hazardous event. Engineering units are 1/year.
Severity (S): An estimated numeric value of the severity of a consequence. Although different engineering units can be used for Severity, one of the more common units is dollars. More severe consequences are assigned higher dollar values than less severe consequences.
Safeguard: can include a system (SIS, BPCS) or mechanical device (PSV), or inherent safe design and/or procedures (includes inspections, alarm response, etc.) that has been put in place to reduce the likelihood of a hazardous event occurring, or to reduce the severity of a consequence if the hazardous event should occur.
Probability of Failure on Demand (PFD): The statistical probability that a safeguard will not function as designed when it is needed.

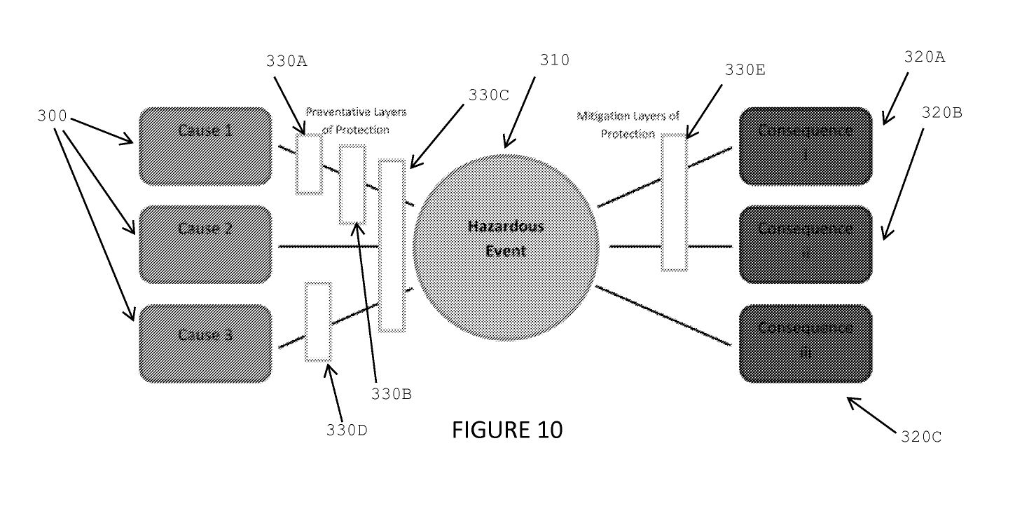

Layer of Protection Analysis (LOPA) is defined by the Center for Chemical Process Safety (CCPS) as: “a process (method, system) of evaluating effectiveness of independent protection layer(s) in reducing the likelihood or severity of an undesirable event”. In a LOPA, industry-specific equipment failure rates are used to bring the frequency of hazardous scenarios to below a specified threshold. A CCPS guidebook was written in 2001 to guide industry in performing LOPAs, including some example failure rate data which could be used in the analysis. In order to explain the LOPA process, a Bowtie configuration will be used as a visualization of the hazardous scenarios under review and is shown in FIG. 10.

A LOPA analyzes multiple causes leading to one hazardous event. In FIG. 10, these causes 300 are listed on the left with lines connecting to one hazardous event 310. Each hazardous event 310 can lead to one of many consequences 320A, 320B, 320C, represented by lines from the hazardous event 310 to the consequences 320A, 320B, 320C on the right. Barriers, or Layers of Protection 330A, 330B, 330C, are put in place to prevent causes leading to the hazardous event (preventive layers), or to prevent the hazardous event from leading to the consequences (mitigation layers). Each layer 330A, 330B, 330C, 330D, 330E may not be effective on every cause or consequence, and this is represented by the layers (A, B, C, D, and E) only covering the lines which are protected by the respective layers. An example hazardous event may be a loss of containment of a flammable liquid, while an example cause could be a failed level control valve. Consequences could be an operator fatality. A preventive layer could be a high level alarm with operator action while fire and gas detection is a mitigation layer. Each cause is given a certain Initiating Event Frequency (IEF) based on known industry failure rates. As well, layers of protection are given a Probability of Failure on Demand (PFD), which represents the fact that layers will not always be effective, due to a variety of possible failures. For example, industry data shows that an alarm with operator action is approximately 90% effective. That is, the PFD of an alarm with operator action is 0.1. A mitigated frequency (MF) for each consequence is calculated from the IEFs and PFDs using Equation (5) below:

MF=Σ(IEF×PFD_{Total})_{for each cause} (5)

In the example bowtie in FIG. 10, this formula for Consequence i would expand to (Equation (6)):

MF=IEF₁×PFD_{A}×PFD_{B}×PFD_{C}×PFD_{E}+IEF₂×PFD_{C}×PFD_{E}+IEF₃×PFD_{E}×PFD_{C}×PFD_{E}

The mitigated frequency represents an order-of-magnitude approximation of the frequency of any events leading to Consequence i (320A). To solve a LOPA scenario, the MF for all consequences should be lower than a pre-determined Tolerable Frequency (TF). Companies determine an acceptable TF based on industry and societal standards. Since the MF is determined using industry experience and the experience of the LOPA participants, the MF value represents an objective and statistical approximation of the frequency of hazardous consequences in a facility. Since it is impossible to reduce the frequency of consequences to zero, as long as the mitigated frequency remains below the tolerable frequency, the facility can be considered safe to within company standards.

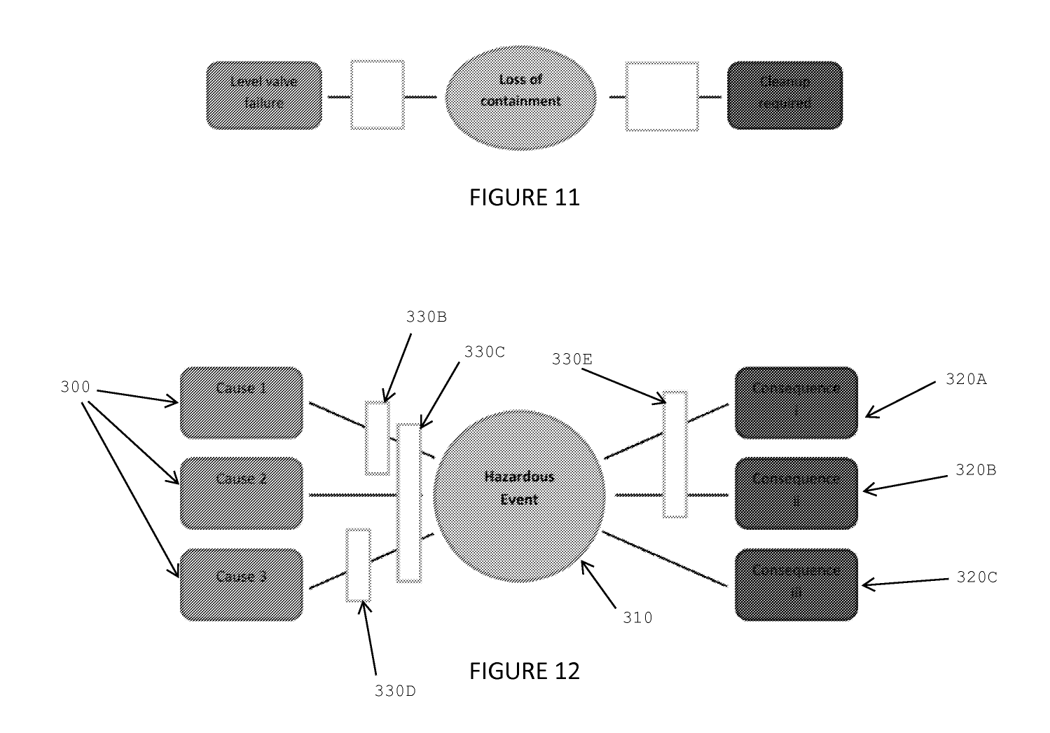

The LOPA ensures that design risk (MF) is lower than the tolerable risk (TF). However, it cannot be depended on that the design risk stays static through the life of a facility. Protection layers fail when they are not maintained, are not tested adequately, or are bypassed. Also, certain safeguards involving operator action are directly affected by changes in operation staff, including turnover and fatigue. Given existing technology, the status of the majority of layers of protection can be monitored by computerized systems as detailed above. As such, it is possible to monitor if a layer of protection is expected to work within the design PFD or if the layer of protection will not be effective. This means that mitigated frequencies can be re-calculated in real time with the current status of safeguards, using the same data as was used in a LOPA. To differentiate this newly calculated Mitigated Frequency from the design MF, the term Projected Frequency (PF) can be used. A simple scenario with one cause leading to one consequence is analyzed, using FIG. 11, to better explain the concept.

If an IEF of 0.1/year and PFDs of 0.1 (High Level alarm), and 0.01 (dike with leak detection) are assigned, the MF_{design} is 10⁻³. Assuming a TF of 10⁻³, the LOPA scenario would be closed. If, during operation, the level alarm is bypassed for maintenance, there will be a period where the PF is 10⁻², which is above the TF. Statistically, cleanup will be required approximately 10 times more than is acceptable during the period that the level alarm is out of service. The risk increases further if the level alarm is left out of service and leak detection in the dike is bypassed (1000 times more incidents). The same math can be applied to all LOPA scenarios including more complicated scenarios with multiple causes for which layers of protection do not apply to every cause.

From the Projected Frequency, it is clear that an estimate of the increase in event frequencies versus tolerable levels can be calculated. While this could be used as a process safety metric, the resulting value can be misleading and abstract because it does not directly take into account the severity of incidents along with the frequency. To make this metric more familiar the PF can be converted to a Risk Performance Indicator (RPI).

Risk in every form is represented most simply by:

Risk=Frequency×Severity (7)

It has already been determined that there is a certain amount of risk that is acceptable, which would be defined per LOPA scenario as:

Tolerable Risk=TF×Severity (8)

Projected Frequency allows for using Equation (7) to produce Projected Risk:

Projected Risk=PF×Severity (9)

Typically, only the frequency of a consequence is affected by a Layer of Protection, rather than the severity. This enables the calculation of the gap between tolerable risk and projected risk based only on frequencies. The Risk Performance Indicator per scenario (RPI_{scen}) is defined as follows:

$$\begin{matrix}{RPI}_{scen} = Projected Risk - Tolerable Risk \\ = Severity \times ( PF - TF )\end{matrix} \qquad ( 10 )$$

Due to the potential that Projected Risk is lower than Tolerable risk, it is possible for Equation (10) to result in a negative number. However, a negative result means that there is no additional risk above the tolerable risk. Any calculation resulting in a negative number should result in an RPI_{scen} of zero.

One of the greatest challenges for mathematical analysis of risk is putting values to consequences such as human life or environmental impact. While it is possible for the Severity unit to be dollars, this is not required for the calculation of RPI_{scen}. The intent of the metric is merely to provide comparison between scenarios and facilities, and as long as the same value is used for similar consequences throughout the scenarios and facilities being analyzed, the units are unimportant. Consequences values are determined in a LOPA and to determine the RPI_{scen} a value may be assigned to these consequences based on a company standard. Weighting is possible depending on the risk neutrality of a company.

RPI_{scen} is an estimation of the risk impacts to an organization on a per-scenario basis. Due to the nature of the LOPA process, RPI_{scen} has units of [units chosen for consequence] per year per scenario. As such, it is simple to determine an overall facility or unit risk metric: simply sum the RPI_{scen} provided by all scenarios within the area under review. This produces a process safety metric which will be referred to as Risk Performance Indicator sum (RPIₛᵤₘ). Due to the nature of the LOPA data, RPIₛᵤₘ is an objective and statistical leading indicator of process safety impact, financial or otherwise, for an area. As layers of protection in a facility fail, RPIₛᵤₘ will increase, and as layers of protection are re-instituted, RPIₛᵤₘ will decrease. This provides a real-time leading process safety metric. Tracking RPIₛᵤₘ over time gives managers and owners of facilities metric increasing or decreasing risk, without the need for process safety events to occur.

It should be clear that the RPIₛᵤₘ can be used as the metric tracked and provided to a safety operator in the risk monitoring system described above.

Due to the size of facilities over which RPIₛᵤₘ could be calculated, it is possible for some risk to be hidden. If there are several layers of protection failures occurring over time with small risk gaps, a sudden jump in one scenario may affect the RPIₛᵤₘ by only a small percentage, while in actuality the facility risk has gone up considerably. A solution is to introduce a second metric, RPIₘₐₓ, which is the maximum RPI value of all scenarios within a facility or unit at a particular moment in time. This should not be confused for the maximum value of RPIₛᵤₘ over a given length of time.

RPIₘₐₓ is the highest risk the facility is exposed to at any point in time. Beyond the obvious uses such as prioritization of attention and maintenance, RPIₘₐₓ can be used to track bad actors. If a single scenario is consistently contributing to the value for RPIₘₐₓ, a root cause analysis can be performed to determine why such risk spikes are occurring.

The bowtie illustration used in FIG. 10 can be used as an example calculation. In this case, the LOPA determined Causes 1-3 have Initiating Event Frequencies (IEF) shown in Table 1 below. PFDs of layers of protection A-E are shown in Table 2 below. Using these values, the LOPA analysis was performed and the MF and TFs are shown in Table 3 below. Consequences i and ii were given consequence value of C5, and Consequence iii was given a value C4. C5 has a TF of 10⁻⁴ and a Severity of 300,000 while C4 has a TF of 10⁻³ and a Severity of 40,000, representing a slight weighting to avoid higher severity events.

TABLE 1
Example Cause Initiating Event Frequencies

| | IEF |
|---|---|
| | (1/y) |
| Cause 1 | 0.1 |
| Cause 2 | 0.01 |
| Cause 3 | 0.1 |

TABLE 2
Example Layer of Protection Probability of Failure on
Demand

| | PFD |
|---|---|
| Layer of | 0.1 |
| Protection A | |
| Layer of | 0.1 |
| Protection B | |
| Layer of | 0.01 |
| Protection C | |
| Layer of | 0.1 |
| Protection D | |
| Layer of | 0.4 |
| Protection E | |

TABLE 3
Example LOPA Results

| | Cons. | | | |
|---|---|---|---|---|
| | Severity | TF | MF | Severity |
| Consequence i | C5 | 1.00E-04 | 8.40E-05 | 300,000 |
| Consequence ii | C5 | 1.00E-04 | 8.40E-05 | 300,000 |
| Consequence iii | C4 | 1.00E-03 | 2.10E-04 | 40,000 |

Three deviations are considered. The first is a failure of Layer A, which has a PFD of 0.1. To calculate the PF1, the bowtie illustration in FIG. 12 is used.

The formula PF for Consequence i is now:

PF=IEF₁×[PFD_{B}PFD_{C}PFD_{E}]+IEF₂×[PFD_{C}PFD_{E}]+IEF₃×[PFD_{D}PFD_{C}PFD_{E}]=1.2E-4

The TF from the LOPA for Consequence i was TF=1E-4, and the Severity was 300,000. To calculate the RPI_{scen}, the Equation (10) is used:

RPI_{scen}=Severity×(PF−TF)=300,000×(1.2E-4−1E-4)=6

This number is fairly low because the MF from the LOPA was low compared to the TF. Repeating this analysis for Consequences ii and iii provides results shown in Table 4 below. For Consequence iii, the PF is still below the tolerable frequency and Equation (10) results in a negative number. However, RPI_{scen} is being calculated and there is no risk gap if the PF is below the TF. Therefore, this value is zero (0).

TABLE 4
RPI_{scen} calculation for failure of Layer A

| | TF | Severity | PF | RPI_{scen} |
|---|---|---|---|---|
| Consequence i | 1.00E-04 | 300,000 | 1.20E-04 | 6 |
| Consequence ii | 1.00E-04 | 300,000 | 1.20E-04 | 6 |
| Consequence iii | 1.00E-03 | 40,000 | 3.00E-04 | 0 |

The RPIₛᵤₘ for this deviation is 12 and the RPIₘₐₓ is 6. These numbers are not very large, but performing the same calculations for failure of Layer C provides considerably higher numbers, shown in Table 5 below.

TABLE 5
RPI_{scen} Calculation for failure of Layer C.

| | TF | Severity | PF | RPI_{scen} |
|---|---|---|---|---|
| Consequence i | 1.00E-04 | 300,000 | 8.40E-03 | 2,490 |
| Consequence ii | 1.00E-04 | 300,000 | 8.40E-03 | 2,490 |
| Consequence iii | 1.00E-03 | 40,000 | 2.10E-02 | 800 |

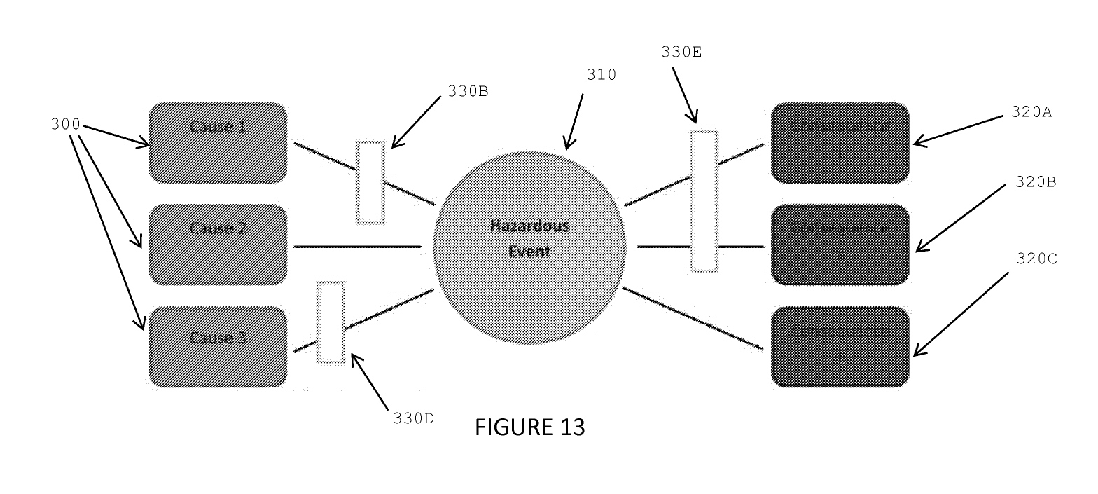

The RPIₛᵤₘ and RPIₘₐₓ are now 5,780 and 2,490 respectively in this deviation, or approximately 450 times more severe than the Layer A failure. The same calculations can also be performed for multiple layer failures which can compound over time. Consider Layer A and C failing, as shown in FIG. 13.

The PF equation and RPI_{scen} for Consequence i now become:

PF=IEF₁×[PFD_{B}PFD_{E}]+IEF₂×[PFD_{E}]+IEF₃×[PFD_{D}PFD_{E}]=1.2E-2

RPI_{scen}=300,000×(1.2E-2−1E-4)=3,570

Repeating this analysis provides the results seen in Table 6 below with an RPIₛᵤₘ of 8,300 and an RPIₘₐₓ of 3,570.

TABLE 6
RPI_{scen} Calculation for failure of Layer A and C

| | TF | Severity | PF | RPI_{scen} |
|---|---|---|---|---|
| Consequence i | 1.00E-04 | 300,000 | 1.20E-02 | 3,570 |
| Consequence ii | 1.00E-04 | 300,000 | 1.20E-02 | 3,570 |
| Consequence iii | 1.00E-03 | 20,000 | 3.00E-02 | 1,160 |

As noted in the literature, process safety metrics require releases to occur before the metric can be calculated. With the RPI metrics, no release is required since the metrics are an estimation of consequence occurrences due to layer of protection failure. When a layer of protection fails, there is no release until a hazardous event occurs. As such, the RPI metrics are true leading indicators which require no releases to be calculated. Also, any industry which can perform a LOPA can use the RPI metric, therefore process safety metrics are no longer limited to downstream process. This, combined with the possibility to “weight” the consequences could theoretically lead to a metric that can be compared across facilities, companies, and even industries.

RPI metrics, are based at a single hazardous event scenario, and as such are not limited by the size of the facility. A unit with only a single hazardous event can be reviewed as effectively as a facility with thousands of potential hazardous scenarios, because the metric is not tied to the recording of past incidents.

Existing metrics from API RP-754 are insufficient as they are targeted towards the oil processing industry only, and may not be valid for tracking process safety in small facilities. A Layer of Protection Analysis (LOPA) allows for the creation of a new metric called Risk Performance Indicator (RPI) which is an estimation of the probable future hazardous event frequency based on the current status of layers of protection in an area or facility. RPI can be split into two sum-metrics, RPIₛᵤₘ and RPIₘₐₓ. RPIₛᵤₘ allows for the trending of overall facility risk considering all layers of protection losses. RPIₘₐₓ shows sudden spikes in risk in particular area while identifying bad actors in terms of process safety risk. Together, the RPI metrics overcome the possible issues of API RP-754. As well, the RPI can be calculated in any industry which can perform a LOPA, which is to say any industry with failure rate data, and is therefore not limited to downstream oil and gas. Most importantly, the RPI metrics are a leading indicator of process safety, meaning that no releases are required to trend process safety in a facility.

The above described RPI metric, whether it is the RPIₛᵤₘ or the RPIₘₐₓ, can be used as the risk metrics being tracked in the system described above. As an example, each contingency tracked by the system can correspond to a mitigation layer of protection or a preventive layer of protection as illustrated in FIG. 10. As a further example, the risk bar noted above can be based on the RPIₛᵤₘ for a facility as a whole. Or, in another example, the RPIₘₐₓ can be tracked separately in the user interface to determine which components are contributing to the overall risk.

The RPI metric can be implemented using the calculation module noted above. The calculation module can determine the relevant RPI metric using the design risk from design documents as well as changing risk conditions. This is displayed on a graph over time or in a snapshot at the current time or at a past time to allow for comparison of facility risk.

For a better understanding of the invention, it should be clear that each hazardous event is provided with its own bowtie illustration on the user interface. This bowtie illustration can be presented to any user as necessary. As in FIG. 10, each illustration has the hazardous event at the center of the illustration with the potential causes being listed on the left and the potential consequences being listed on the right.

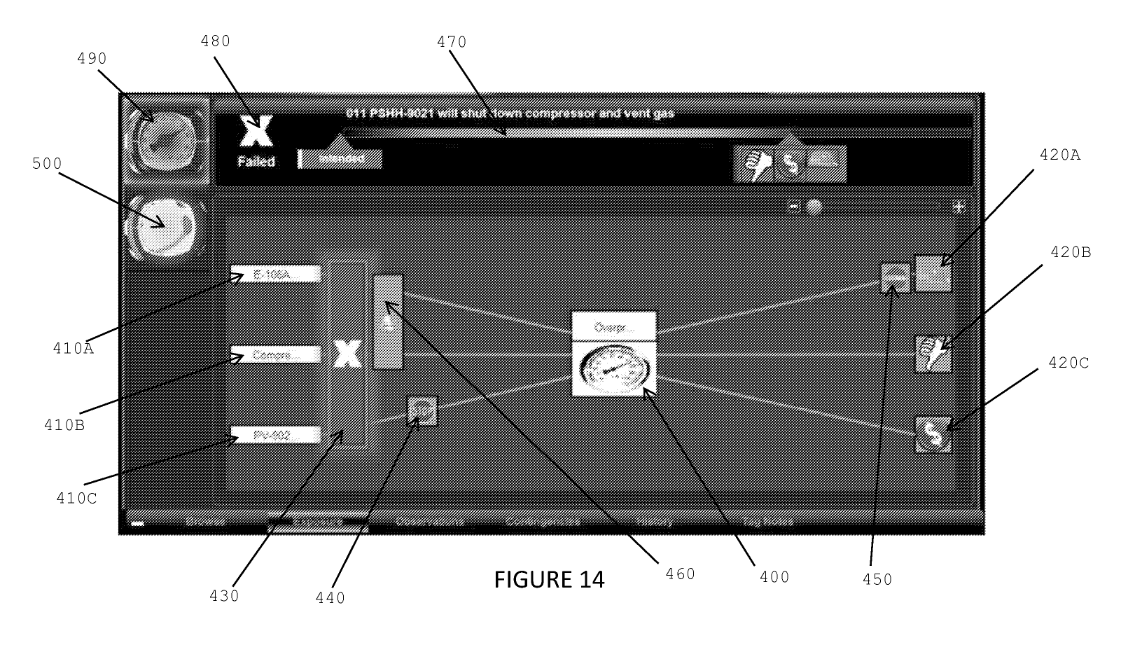

Referring to FIG. 14, a screen shot of a user interface screen presenting a bowtie configuration for a specific event is illustrated. The specific event 400 is at the center of the interface while the potential causes 410A, 410B, 410C are on the left of the screen. The potential consequences 420A, 420B, 420C are listed on the right of the screen. Safeguard 430 is illustrated as overlapping connections between the causes and the specific event. Safeguard 430 is provided to represent a safeguard to prevent the specific event from occurring if one or more of the causes 410A, 410B, 410C occur. For the screen shot in FIG. 14, the safeguard 430 has been implemented and has failed, as shown by the “X” on the box representing the safeguard. Safeguards 440 and 460, also designed to prevent or at least warn of the occurrence of at least one of causes 410A, 410B, 410C are shown to be operative. Safeguard 450, designed to prevent consequence 420A, and is shown as still being functional.

Also as part of the user interface in FIG. 14, a risk bar 470 is provided at the top of the screen. An indicator 480 indicates whether a highlighted safeguard is functional or if it has failed. In FIG. 14, the highlighted safeguard is safeguard 430. The indicator 480 shows that the safeguard 430 has failed. Bowtie indicators 490, 500 are also provided to give a user quick access to other bowties configurations. For every specific event that is being monitored, a bowtie configuration is created. These bowties can be quickly accessed by clicking on a bowtie indicator. Each bowtie indicator can be color-coded to indicate the risk level for each specific event being monitored. As an example, the bowtie indicator 490 represents the event 400. Since this event indicates grave danger of occurring due to the failure of the safeguard 430, the bowtie indicator 490 is colored red. On the other hand, the bowtie indicator 500 is colored yellow to indicate that the specific event being tracked for that bowtie configuration is in a yellow state of alert.

The user interface of the invention provides a user with analysis tools so that normal facility occurrences and abnormal facility occurrences can be understood in terms of risk impact. This includes normal process alarms and allows alarms to be interpreted and then prioritized as the user will be able to quickly establish the impact on risk. This also includes running what if scenarios where safeguards and/or procedures would be stopped or bypassed or inhibited. Also provided are contingencies for temporarily reducing the risk of running with failed safeguards. When contingencies are implemented, these occurrences are recorded and recommendations are made to the user. The user interface allows engineering data, specifications, assumptions related to every safeguard to be examined or edited.

The user interface also has access to a database of safety related documents including SRS, HAZOP, LOPA, procedures, and drawings. This allows the user to use the interface to determine if safety procedures for the components of the facility are being implemented.

The embodiments of the invention may be executed by a computer, processor, or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may contain software which executes such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above, all of which are intended to fall within the scope of the invention as defined in the claims that follow.

Having thus described the invention, what is claimed as new and secured by Letters Patent is:

1. A system for monitoring safeguards and procedures relating to probable potential hazardous events in a facility; the system comprising:
A user interface for providing a user with analysis tools and alarms relating to hazardous events in said facility;
A database of safety related documents, said documents being accessed by said user interface to determine if safety procedures for said plurality of components are being implemented;
a safety calculation module for calculating risk levels if said safeguards and procedures for said plurality of components are not operative or implemented, said risk levels being presented to said user through said user interface, said risk levels being related to at least one consequence if said safety procedures are not implemented;
Wherein said safety calculation module calculates an overall risk level for each scenario using a risk performance indicator metric, said risk performance indicator metric being calculated as tolerable risk subtracted from projected risk.

2. A system according to claim 1, wherein said system provides alerts, analysis, what if scenarios, operator observations, and scheduled safety inspections for each of said plurality of components on said user interface.

3. A system according to claim 2, wherein missed safety inspections, maintenance and testing procedures are presented on said user interface using a timeline.

4. A system according to claim 1, wherein in the event of a potentially unsafe situation concerning at least one of said hazardous events, said user interface provides contingency options to said safety operator.

5. A system according to claim 1, wherein each potential consequence of a potentially unsafe situation is assigned a mitigated frequency metric, said mitigated frequency metric being based on a probability of failure of at least one layer of protection to prevent or mitigate said consequence.

6. A system according to claim 5, wherein said mitigated frequency metric is calculated as a sum of metrics for each potential cause of said potential consequence and each layer of protection to prevent or mitigate said consequence.

7. A system according to claim 6, wherein said metrics for each potential cause and each layer of protection is calculated as said potential cause's initiating event frequency multiplied by each relevant layer of protection's probability of failure on demand.

8. A system according to claim 5, wherein said mitigated frequency metric is calculated as:
MF=Σ(IEF×PFD_{Total})_{for each potential cause}
Where:
IEF is an initiating event frequency for a potential cause for said potential consequence
PFD_{Total} is a total probability of failure on demand for all layers of protection affected by said potential cause leading to said potential consequence.

9. A system according to claim 1, wherein in the event of a potentially unsafe situation concerning at least one of said plurality of components, said user interface provides said user operator with potential consequences for said unsafe situation.

10. A system according to claim 1, wherein said risk levels are related to a risk that said potential consequences will probably occur if said unsafe situation occurs.

11. A system according to claim 1, wherein a facility risk metric for a specific area in said facility is calculated by summing all risk performance indicator metrics for all scenarios within said specific area.

12. A system according to claim 10, wherein, for each contingency option provided to said user, said user interface also provides a modified risk level relating to failed safeguards and procedures, said modified risk level being a risk level where consequences will be more likely to occur on a process demand, each contingency option, if implemented, reduces a likelihood that said hazardous event occurs.

13. A system according to claim 1, wherein said user interface displays unsafe situations to said user on a historical timeline.

14. A system according to claim 5, wherein said user interface displays a risk level for said unsafe situation, said risk level being calculated by said safety calculation module, said user interface displaying a modified risk level for each failed safeguard or procedure.

15. A system according to claim 1, wherein for each unsafe situation concerning at least one of said plurality of components, a user interface displays a listing of probable consequences if failed safeguards and procedures occur.

16. A system according to claim 1, wherein each one of said potential consequences is classified as to severity of said consequence.

17. A system according to claim 1, wherein each one of said potential consequences is classified according to a plurality of categories.

18. A system according to claim 14, wherein said plurality of categories includes at least one of:
safety
environmental
economic/asset loss
reputation

19. A system according to claim 1, wherein said user interface displays to said safety operator at least one contingencies option currently implemented.

20. A system for monitoring safeguards and safety related procedures relating to Process Risk Management and Safety in a facility, the system comprising:
A user interface for providing alarms and information relating to said specific components;
a database of safety related documents, said documents being accessed by said user interface to record and display design assumptions, design conditions, design environment, and functionality of said safeguards;
a safety calculation module for calculating risk levels relating to potential probable consequences if said safeguards and procedures for said specific components, devices, systems are not implemented, bypassed, failed, or inhibited in any way being presented to said users through said user interface, said safety calculation module calculating said risk levels on a per scenario basis using a severity of consequence multiplied by a difference between projected risk and tolerable risk.
